(19) United States
(12) Patent Application Publication
(10) Pub. No.: US 2023/0083712 A1
(43) Pub. Date: Mar. 16, 2023

(54) UNFAIR TRANSACTON VISUALIZATION DEVICE, METHOD, AND PROGRAM

(71) Applicant: NEC Corporation, Minato-ku, Tokyo (JP)

(72) Inventor: Kenji Fukuda, Tokyo (JP)

(73) Assignee: NEC Corporation, Minato-ku, Tokyo (JP)

(21) Appl. No.: 17/802,235

(22) PCT Filed: Mar. 19, 2021
(86) PCT No.: PCT/JP2021/011405

§ 371 Date: Aug. 25, 2022

(30) Foreign Application Priority Data
Mar. 23, 2020 (JP) 2020-050540

(51) Int. Cl. G06Q 40/04

(52) U.S. Cl. CPC G06Q 40/04

(57) ABSTRACT

The candidate list output means 81 outputs a list of unfair transaction candidates indicating one or more transactions suspected of being of a specified type of unfairness. The candidate input means 82 accepts a selection of an unfair transaction candidate from the output list of the unfair trade candidates. The unfair transaction output means 83 displays target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

### TECHNICAL FIELD

This invention relates to an unfair transaction visualization device, an unfair transaction visualization method, and an unfair transaction visualization program that visualize a stock transaction suspected of being unfair.

### BACKGROUND ART

In recent years, online trading via the Internet has developed, making it easier for many investors to trade stocks. On the other hand, as stock trading has become easier, the risk of unfair practices such as intentional manipulation of stock market prices has increased, and it is desirable to be able to properly monitor such unfair transactions.

Among the unfair transactions in stock trading, spoofing, wash trade, etc. are known as unfair transactions that can be detected by AI (Artificial Intelligence). Spoofing refers to the act of frequently repeating order, cancellation, and correction of a large number of buy and sell orders with no intention of closing a trade, in order to mislead other investors into believing that a particular stock is being actively traded and to induce them to trade. Wash trade refers to transactions in which the same person places both buy and sell orders at the same time and at the same price, without the purpose of transferring rights.

For example, Patent Literature 1 describes a method that allows automatic or manual detection of suspicious activity against a client account by means of information provided in the visualization. The method described in Patent Literature 1 visualizes changes in client account balances and detects unusual deposits and withdrawals, as well as large swings in trading activity on a particular stock just prior to a major announcement that could affect the stock price, as unfair transaction.

### CITATION LIST

### Patent Literature

Patent Literature 1: Japanese Unexamined Patent Application Publication No. 2016-520918

### SUMMARY OF INVENTION

### Technical Problem

On the other hand, the final judgment as to whether a detected transaction is truly unfair or whether a bona fide user made a similar pattern of transactions based on economic judgment is made by the stock exchange or brokerage firm personnel. Therefore, an easy-to-understand method of displaying transactions that have been determined by the AI to be potentially unfair is desired.

The method described in the Patent Literature 1 detects unfair transactions based on their relationship to events. However, the above-mentioned Spoofing and Wash trade are not necessarily transactions that are judged based solely on their relationship with a specific event. Therefore, the method described in Patent Literature 1 has the problem of not being able to visualize unfair transactions that are not associated with events.

The method described in Patent Literature 1 also detects large deposits and withdrawals that are detected. However, there are many cases where such transactions themselves are not considered unfair transactions, and if all of them are detected and visualized, the number of details to be checked would increase. Therefore, it is desirable to be able to focus on stock transactions that are suspected of being unfair and visualize them in a manner that is easy for the person in charge to understand.

Therefore, it is an exemplary object of the present invention to provide an unfair transaction visualization device, an unfair transaction visualization method, and an unfair transaction visualization program that can visualize stock transactions suspected of being unfair in an easy-to-understand manner.

### Solution to Problem

An unfair transaction visualization device according to the present invention including: a candidate list output means which outputs a list of unfair transaction candidates indicating one or more transactions suspected of being of a specified type of unfairness; a candidate input means which accepts a selection of an unfair transaction candidate from the output list of the unfair transaction candidates; and an unfair transaction output means which displays target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

An unfair transaction visualization method according to the present invention including: outputting a list of unfair transaction candidates indicating one or more transactions suspected of being of a specified type of unfairness; accepting a selection of an unfair transaction candidate from the output list of the unfair trade candidates; and displaying target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

The unfair transaction visualization program according to the present invention causing a computer to execute: a candidate list output process of outputting a list of unfair transaction candidates indicating one or more transactions suspected of being of a specified type of unfairness; a candidate input process of accepting a selection of an unfair transaction candidate from the output list of the unfair trade candidates; and an unfair transaction output process of displaying target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

### Advantageous Effects of Invention

The invention allows for easy-to-understand visualization of stock transactions that are suspected of being unfair.

### BRIEF DESCRIPTION OF DRAWINGS

FIG. 1 It depicts a block diagram illustrating a configuration example of one exemplary embodiment of an unfair transaction visualization device according to the present invention.

FIG. 2 It depicts an explanatory diagram illustrating an example of a screen that accepts input of a type of an unfairness.

FIG. 3 It depicts an explanatory diagram illustrating an example of a screen that outputs a list of unfair transaction candidates.

FIG. 4 It depicts an explanatory diagram illustrating an example of first screen that visualizes unfair transaction candidates.

FIG. 5 It depicts an explanatory diagram illustrating an example of second screen that visualizes unfair transaction candidates.

FIG. 6 It depicts an explanatory diagram illustrating an example of third screen that visualizes unfair transaction candidates.

FIG. 7 It depicts an explanatory diagram illustrating an example of fourth screen that visualizes unfair transaction candidates.

FIG. 8 It depicts an explanatory diagram illustrating another example of the fourth screen that visualizes unfair transaction candidates.

FIG. 9 It depicts an explanatory diagram illustrating an example of displaying multiple screens that visualize unfair transaction candidates.

FIG. 10 It depicts a flowchart illustrating an example of the operation of the unfair transaction visualization device.

FIG. 11 It depicts a flowchart illustrating another example of the operation of the unfair transaction visualization device.

FIG. 12 It depicts a block diagram showing an overview of an unfair transaction visualization device according to the present invention.

### DESCRIPTION OF EMBODIMENTS

Hereinafter, exemplary embodiments of the present invention will be described with reference to drawings.

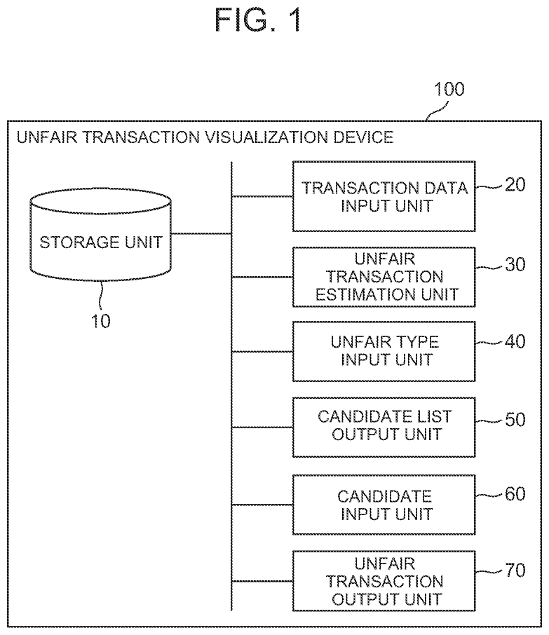

FIG. 1 is a block diagram illustrating a configuration example of one exemplary embodiment of an unfair transaction visualization device according to the present invention. The unfair transaction visualization device 100 of this exemplary embodiment includes a storage unit 10, a transaction data input unit 20, an unfair transaction estimation unit 30, an unfair type input unit 40, a candidate list output unit 50, a candidate input unit 60, and an unfair transaction output unit 70.

The storage unit 10 stores information necessary for the unfair transaction visualization device 100 to perform various processes. The storage unit 10 may, for example, store transaction data input by the transaction data input unit 20 described below. The storage unit 10 is realized by, for example, a magnetic disk.

The transaction data input unit 20 inputs transaction data to be visualized. Specifically, the transaction data input unit 20 inputs transaction data for a predetermined period of time (e.g., one day, etc.) as a transaction history. The transaction data may be for one type of issue or for multiple types of issues. The transaction data input unit 20 may also store the input transaction data in the storage unit 10.

In this exemplary embodiment, transaction data includes various types of information related to stock trading. Specifically, the transaction data includes a list of orders, such as sell orders, buy orders, execution of sell orders, execution of buy orders, cancellation orders, or corrections to orders. In addition to the list of orders, the transaction data may also include a best buy quotation or best sell quotation. In addition, the transaction data may include the stock price of the issue at the time of the trade and the board information of the issue.

The unfair transaction estimation unit 30 estimates one or more transactions of suspected unfairness and the type of suspected unfairness (hereinafter sometimes referred to as deception), subject to the input transaction data. The suspected unfair transactions are associated with the type of unfair transaction (i.e., the deception), the customer who conducted a transaction, the issue in which the transaction is conducted, and the time at which the transaction is conducted. In the following description, transactions suspected of being unfair are referred to as an unfair transaction candidate.

The unfair transaction estimation unit 30 may estimate a particular transaction that is suspected of being unfair as an unfair transaction candidate, or may estimate a series of transactions together as an unfair transaction candidate. The series of transactions may include, for example, the triggering transaction and the set of transactions identified as terminated. The series of transactions may also include transactions that are estimated to be terminated as well as transactions that are identified as terminated. The estimated transactions indicate, for example, a predetermined number of transactions or a predetermined amount of time from the transactions identified as having been completed.

The method by which the unfair transaction estimation unit 30 estimates an unfair transaction candidate is arbitrary. For example, the unfair transaction estimation unit 30 may estimate unfair transaction candidates using a model that predicts whether or not a transaction is unfair for each type of unfairness using transaction data as input. For example, when the model for predicting whether a transaction is unfair or not calculates a score indicating unfairness, the unfair transaction estimation unit 30 may estimate the transactions indicated by the transaction data for which the calculated score is greater than a predetermined threshold as an unfair transaction candidate. Furthermore, the unfair transaction estimation unit 30 may rank the unfair transaction candidates according to the score.

It is assumed that the model for predicting whether a transaction is unfair or not is represented by a linear regression equation. In this case, the explanatory variables with larger coefficients in the model can be said to have a greater impact on the estimation of unfair transactions. Therefore, the unfair transaction estimation unit 30 may normalize the coefficients of the model and estimate the factors (explanatory variables) determined to be unfair transaction candidates according to the size of the coefficients of the explanatory variables included in the model. The unfair transaction estimation unit 30 may store the estimated unfair transaction candidates and determined factors in the storage unit 10.

However, the method by which the unfair transaction estimation unit 30 estimates whether a transaction is unfair or not is not limited to using the model described above. The unfair transaction estimation unit 30 may, for example, estimate unfair transaction candidates by detecting transaction histories that are similar to the pattern of transactions for the type of unfairness. For example, when an order, cancellation, or correction of a buy and sell order exceeding a predetermined quantity is repeated more than a predetermined number of times, the unfair transaction estimation unit 30 may estimate that series of transactions as an unfair transaction candidate that indicates Spoofing. For example, when the same person places both buy and sell orders at the same time and at the same price, the unfair transaction estimation unit 30 may estimate that series of transactions as an unfair transaction candidate indicating Wash trade.

The unfair type input unit 40 accepts from a user the designation (e.g., spoofing, wash trade, etc.) of the type (i.e., deception) of transaction that is suspected of being unfair. The unfair type input unit 40 may, for example, display on the screen of the display device (not shown) a list of the types of unfairness that the unfair transaction estimation unit 30 has targeted for estimation, and accept user selection from the list. The designation accepted by the unfair type input unit 40 corresponds to the conditions for the candidate list output unit 50, described below, to extract unfair transaction candidates.

When the types of estimated unfair transaction candidates are not limited, the unfair transaction visualization device 100 need not include the unfair type input unit 40. However, it is preferable that the unfair transaction visualization device 100 includes the unfair type input unit 40 so that the person in charge can easily recognize the type of transaction suspected to be unfair. In addition, the unfair type input unit 40 may input information such as the time period during which the transaction is conducted, the brand, market, and customer, as well as the type of transaction suspected of being unfair.

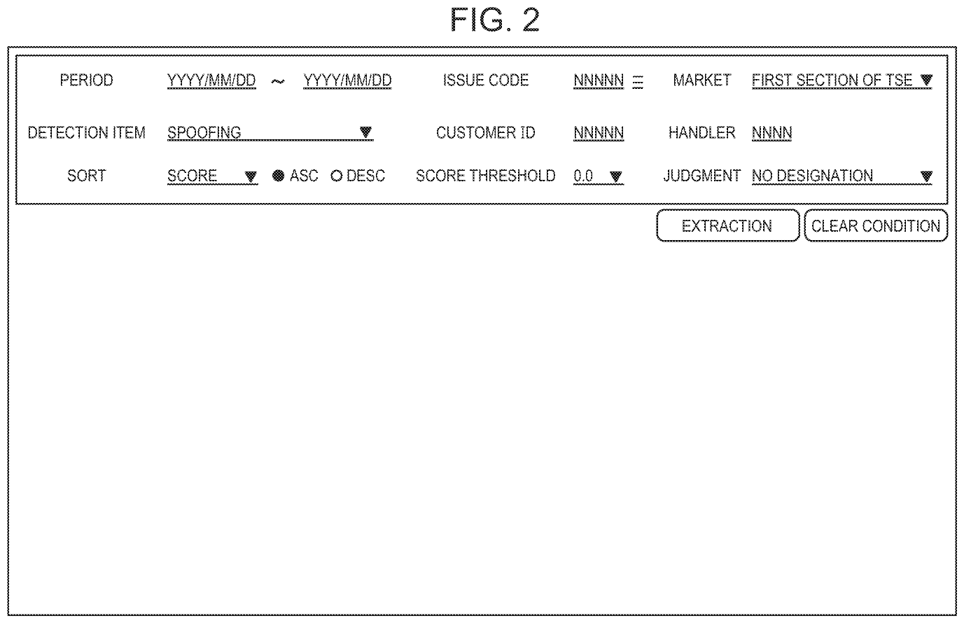

FIG. 2 is an explanatory diagram illustrating an example of a screen where the unfair type input unit 40 accepts input of a type of an unfairness. In the example shown in FIG. 2, the type of unfairness is limited to the type of unfair transaction candidate by selecting the type of unfairness in the “Detection Item” of the screen. In addition to the input of the type of unfairness, the screen illustrated in FIG. 2 also accepts the period, issue code, customer ID, handler, score threshold, and judgment (A to C, etc.) as conditions for narrowing down unfair transaction candidates. The score illustrated in FIG. 2 shows a score indicating unfairness, which is calculated by the model described above. In addition, as illustrated in FIG. 2, the sort order of the unfairness candidates may be specified as a condition for displaying the information.

The candidate list output unit 50 outputs a list of unfair transaction candidates based on the designation received by the unfair type input unit 40. Specifically, the candidate list output unit 50 outputs a list of transactions suspected of being unfair of the specified type (i.e., unfair transaction candidates). When the unfair type input unit 40 accepts the designation of conditions for the unfair transaction candidates, the candidate list output unit 50 may output only the unfair transaction candidates that meet the conditions. As described above, the transactions included in the unfair transaction candidates may be one or more (e.g., a set of triggering transactions and terminations).

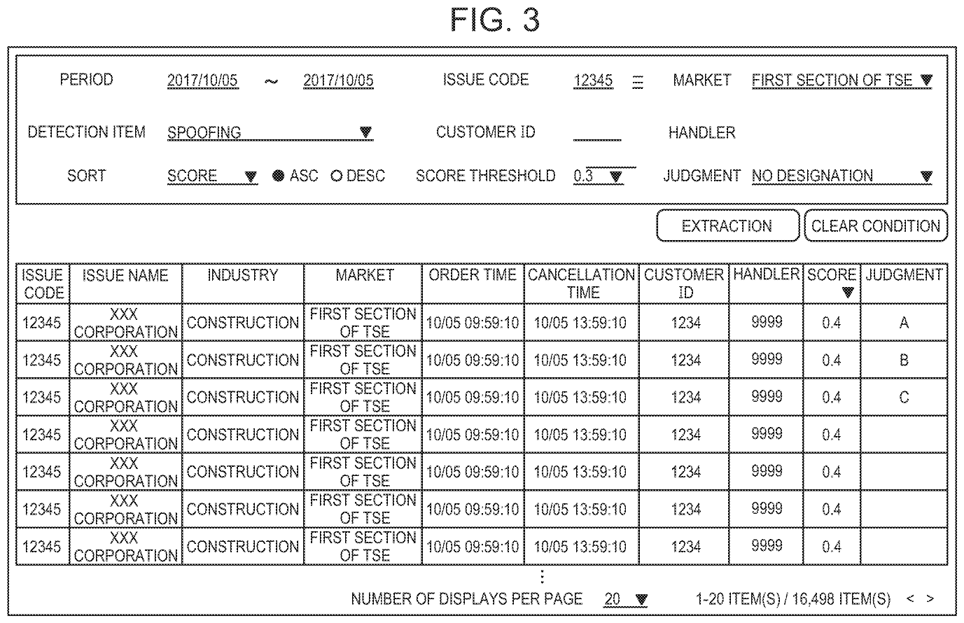

FIG. 3 is an explanatory diagram illustrating an example of a screen that outputs a list of unfair transaction candidates. The example shown in FIG. 3 is an example of search results when the period, the detection item that is the type of unfairness, the issue code, the market, and the score threshold are specified.

The candidate input unit 60 accepts the user's desired selection of unfair transaction candidates from the output list of unfair transaction candidates. The candidate input unit 60 may detect, for example, the unfair transaction candidate selected by the user from the list of unfair transaction candidates via a pointing device. The candidate input unit 60 may also detect unfair transaction candidates that the user taps against the list of unfair transaction candidates displayed on a touch panel.

When factors (explanatory variables) are estimated to be a candidate for an unfair transaction, the candidate input unit 60 may input information indicating the factors (e.g., the weight of the coefficient of each explanatory variable and the top factors) to the unfair transaction output unit 70.

The unfair transaction output unit 70 visualizes the selected unfair transaction candidates. Specifically, the unfair transaction output unit 70 displays transaction data (hereinafter referred to as “target transaction data”) indicating transactions conducted between a transaction that triggered a suspected unfairness of the selected unfair transaction candidate and a transaction that ended the unfairness, in a manner that is distinguishable from other transaction data. For example, the unfair transaction output unit 70 may display the target transaction data in a manner that is distinguishable from other transaction data for the same issue.

The unfair transaction output unit 70 may display the target transaction data in a manner that is distinguishable from other transaction data for the same issue and on the same day, in accordance with the daily stock price changes. The unfair transaction output unit 70 may also display the transaction data indicating transactions conducted between a time of transaction that triggered a suspected unfairness of the selected unfair transaction candidate and a time of transaction at which the unfairness end is estimated, in a manner that is distinguishable from other transaction data.

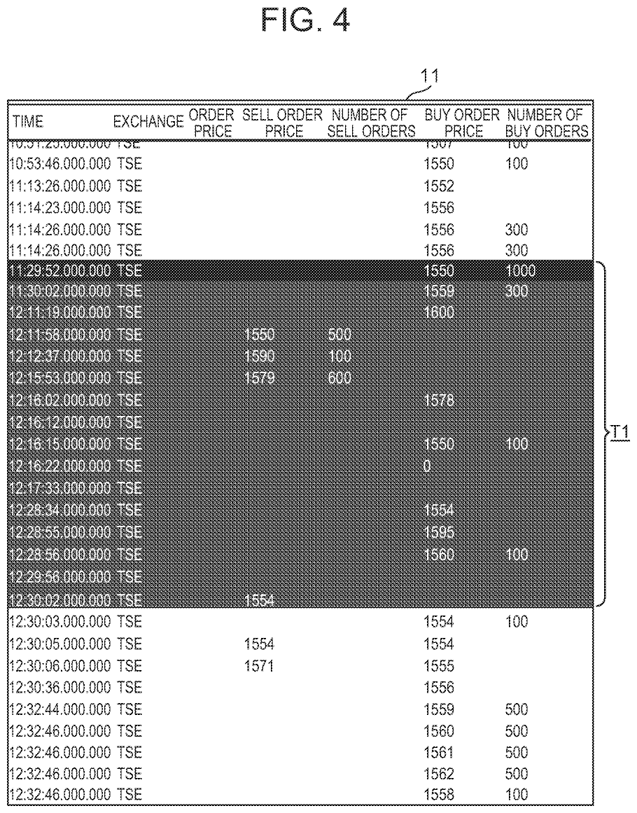

FIG. 4 is an explanatory diagram illustrating an example of first screen that visualizes unfair transaction candidates. The first screen 11 illustrated in FIG. 4 is a screen that displays the transaction history for a predetermined period of time. FIG. 4 shows an example in which the unfair transaction output unit 70 displays a transaction history, which is a list of orders according to an issue of the unfair transaction candidate, and highlights the target transaction data T11 in the transaction history so that it can be distinguished from the transaction data of other periods.

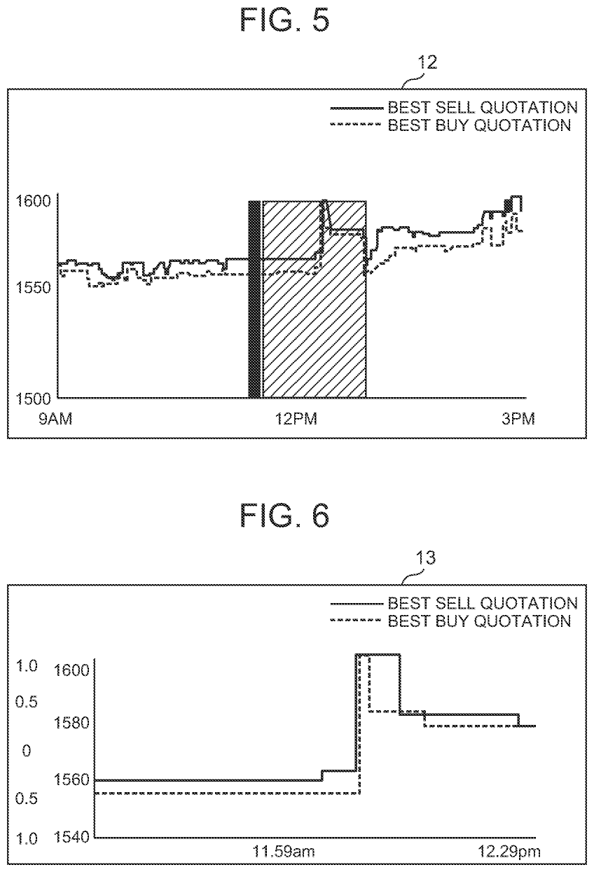

FIG. 5 is an explanatory diagram illustrating an example of second screen that displays unfair transaction candidates. The second screen 12 illustrated in FIG. 5 is a screen that displays a stock price chart included in the transaction data. FIG. 5 shows an example in which the unfair transaction output unit 70 displays a stock price chart for a predetermined period of time, and highlights a stock price fluctuation for a period of time T2 that includes the target transaction data in the stock price chart so that it can be distinguished from stock price fluctuations for other periods of time. When the transaction data includes a best buy quotation and best sell quotation as the stock price, the unfair transaction output unit 70 may display the best buy quotation and best sell quotation on the stock price chart, as illustrated in FIG. 5.

FIG. 6 is an explanatory diagram illustrating an example of third screen that visualizes unfair transaction candidates. The third screen 13 illustrated in FIG. 6 is a screen for enlarging and displaying a part of the stock price chart. The stock price charts are generally created for a predetermined period of time, such as one day or one week. On the other hand, the period including the target transaction data is often shorter than the predetermined period. Therefore, to make it easier to see the stock price fluctuations during that period, the unfair transaction output unit 70 may enlarge the stock price chart for the period including the target transaction data, as illustrated in FIG. 6. FIG. 6 shows an example of an enlarged stock price chart for the period illustrated in FIG. 5.

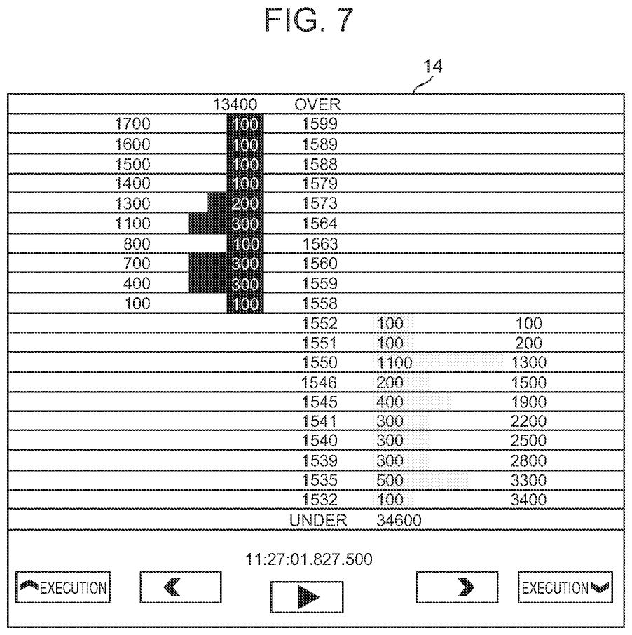

FIG. 7 is an explanatory diagram illustrating an example of fourth screen that visualizes unfair transaction candidates. The fourth screen 14 illustrated in FIG. 7 is a screen that displays board information. FIG. 7 shows an example in which the unfair transaction output unit 70 displays the board information at the time when a particular transaction in the transaction history illustrated in FIG. 4 was specified.

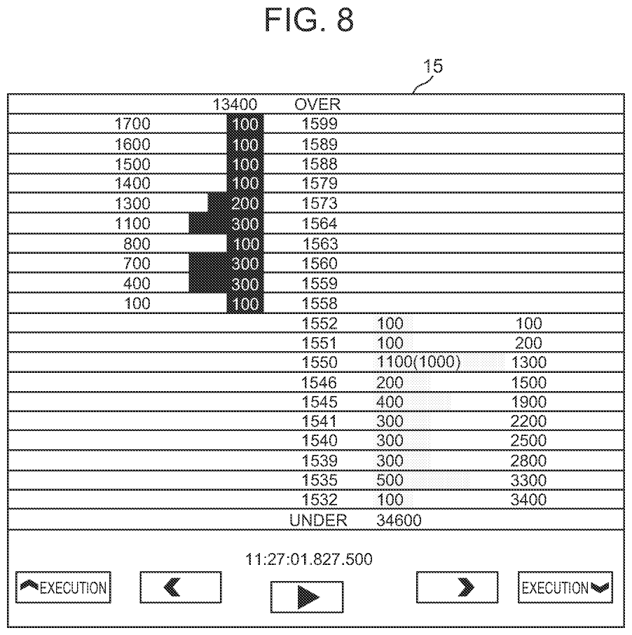

In addition, the unfair transaction output unit 70 may display the order details indicated by the designated trade in correspondence with the board information. FIG. 8 is an explanatory diagram illustrating another example of the fourth screen that visualizes unfair transaction candidates. For example, when the specified transaction is a buy order for 1000 shares for a stock price of 1550 yen, the fourth screen 15 illustrated in FIG. 8 shows an example of the unfair transaction output unit 70 displaying the number of ordered stocks for the transaction with the corresponding stock price in the board information.

Furthermore, when a factor (explanatory variable) that is determined to be a candidate for an unfair transaction is input, the unfair transaction output unit 70 may display a display item corresponding to the factor in a manner that is distinguishable from other display items according to information indicating the factor determined to be an unfair transaction candidate. For example, when order quantity is entered as one of the factors that determined the transaction to be an unfair transaction candidate, the unfair transaction output unit 70 may highlight the order quantity for the relevant transaction. When a score for a factor determined to be an unfair transaction candidate is entered, the unfair transaction output unit 70 may change the brightness or boldness of the corresponding display item according to the score.

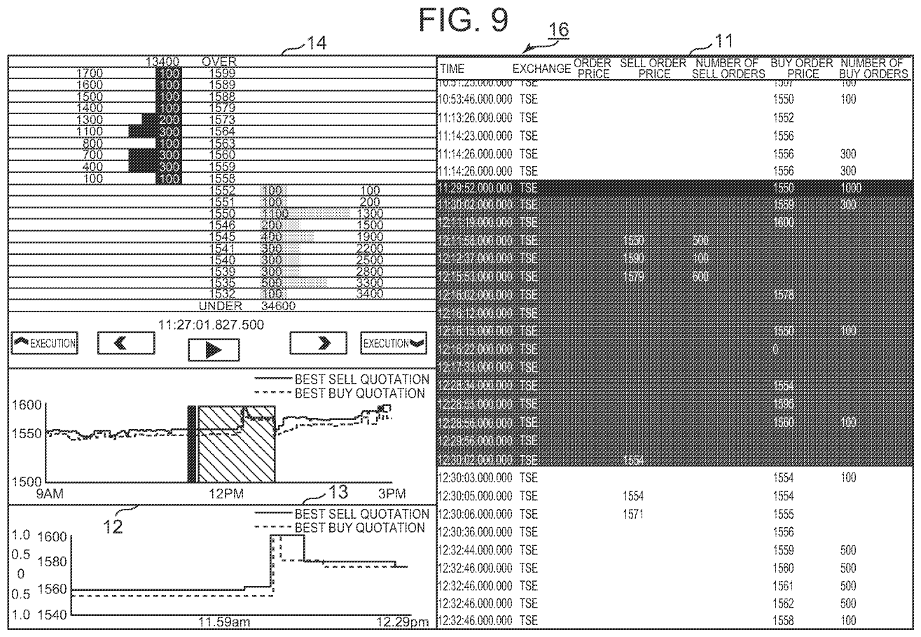

In this exemplary embodiment, the screens for visualizing unfair transaction candidates are illustrated in FIGS. 4 through 7, respectively, but the unfair transaction output unit 70 may display each screen together on a single screen. FIG. 9 is an explanatory diagram illustrating an example of displaying multiple screens that visualize unfair transaction candidates. The screen 16 illustrated in FIG. 9 is the first screen 11, the second screen 12, third screen 13, and fourth screen 14 into one screen. As illustrated in FIG. 9, the multiple screens are grouped together to make it easier to understand their mutual relationships. For example, when the top transaction is selected from the target transaction data illustrated in the first screen 11, the unfair transaction output unit 70 may display on the fourth screen 14 the corresponding board information on which the selected transaction was conducted.

FIGS. 4 through 9 illustrate screens in which the unfair transaction output unit 70 displays the target transaction data in a manner that is distinguishable from other transaction data for the same issue and on a same day. However, the unfair transaction output unit 70 may display the target transaction data over multiple days. In this case, the unfair transaction output unit 70 may display the transaction history illustrated in FIG. 4 over multiple days, or the stock price chart illustrated in FIG. 5 over multiple days (e.g., number of days including the target transaction data, or weekly, etc.).

The transaction data input unit 20, unfair transaction estimation unit 30, unfair type input unit 40, candidate list output unit 50, candidate input unit 60, and the unfair transaction output unit 70 are realized by a processor (for example, CPU (Central Processing Unit), GPU (Graphics Processing Unit)) of a computer that operates according to a program (a data management).

For example, a program may be stored in a storage unit 10, and the processor may read the program and operate as the transaction data input unit 20, unfair transaction estimation unit 30, unfair type input unit 40, candidate list output unit 50, candidate input unit 60, and the unfair transaction output unit 70 according to the program. In addition, the functions of the unfair transaction visualization device may be provided in the form of SaaS (Software as a Service).

The transaction data input unit 20, unfair transaction estimation unit 30, unfair type input unit 40, candidate list output unit 50, candidate input unit 60, and the unfair transaction output unit 70 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the unfair transaction visualization device are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

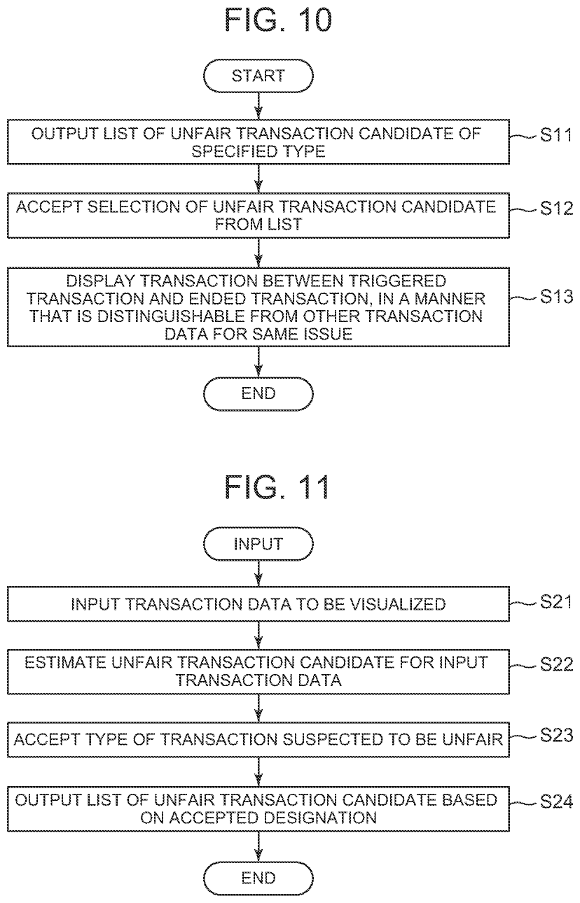

Next, the operation example of this exemplary embodiment of the unfair transaction visualization device will be described. FIG. 10 is a flowchart illustrating an example of the operation of the unfair transaction visualization device 100 according to this exemplary embodiment. The candidate list output unit 50 outputs a list of unfair transaction candidates of the specified type (step S11). The candidate input unit 60 accepts a selection of an unfair transaction candidate from the output list of the unfair transaction candidates (step S12). The unfair transaction output unit 70 displays transactions between a transaction that triggered the selected unfair candidate transaction and a transaction that ended the unfairness, in a manner that is distinguishable from other transaction data for the same issue (step S13).

FIG. 11 is a flowchart illustrating another example of the operation of the unfair transaction visualization device 100 according to this exemplary embodiment. The transaction data input unit 20 inputs transaction data to be visualized (step S21). The unfair transaction estimation unit 30 estimates unfair transaction candidates for the input transaction data (step S22). The unfair type input unit 40 accepts a type of transaction suspected to be unfair (step S23), and the candidate list output unit 50 outputs a list of unfair transaction candidates based on the accepted designation (step S24). Thereafter, the process where the candidate input unit 60 accepts the selection of unfair transaction candidates and the unfair transaction output unit 70 displays the target transaction data in a manner that is distinguishable from other transaction data is the same as the process from step S12 to step S13 illustrated in FIG. 10.

As described above, in this exemplary embodiment, the candidate list output unit 50 outputs a list of unfair transaction candidates, the candidate input unit 60 accepts the selection of unfair transaction candidates from the list, and the unfair transaction output unit 70 displays the target transaction data in a manner that is distinguishable from other transaction data of the same issue. As a result, stock transactions suspected of being unfair can be visualized in an easy-to-understand manner.

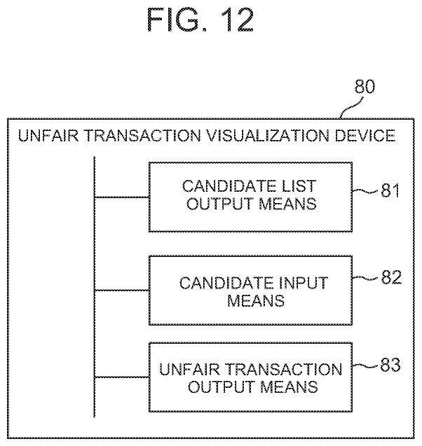

Next, an overview of the present invention will be described. The following is an overview of the invention. FIG. 12 is a block diagram showing an overview of an unfair transaction visualization device according to the present invention. The unfair transaction visualization device 80 (e.g., unfair transaction visualization device 100) according to the present invention includes: a candidate list output means 81 (e.g., candidate list output unit 50) which outputs a list of unfair transaction candidates indicating one or more transactions suspected of being of a specified type of unfairness (e.g., spoofing, wash trade, etc.); a candidate input means 82 (e.g., candidate input unit 60) which accepts (e.g., by a user) a selection of an unfair transaction candidate from the output list of the unfair transaction candidates; and an unfair transaction output means 83 (e.g., unfair transaction output unit 70) which displays target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

Such a structure allows for easy-to-understand visualization of stock transactions that are suspected of being unfair.

The transaction data may include information indicating a sell order, a buy order, an execution of a sell order, an execution of a buy order, a cancellation of an order, or a correction of an order.

The transaction data may include a best buy quotation or best sell quotation.

The unfair transaction output means 83 may display the transaction data indicating transactions conducted between a time of transaction that triggered a suspected unfairness of the selected unfair transaction candidate and a time of transaction at which the unfairness end is estimated, in a manner that is distinguishable from other transaction data for the same issue.

The unfair transaction output means 83 may display the target transaction data in a manner that is distinguishable from other transaction data for the same issue and on a same day.

Specifically, the unfair transaction output means 83 may display (e.g., screen display as illustrated in FIG. 4) a transaction history according to an issue of the unfair transaction candidate, and display the target transaction data in the transaction history in a manner that is distinguishable from the transaction data of other periods. Such a screen allows for easy-to-understand visualization of transaction histories of unfair transaction candidates.

In this case, the unfair transaction output means may display (e.g., screen display as illustrated in FIG. 8) board information at the time the specified transaction is made in the transaction history, and displays the number of ordered stocks for the transaction with the corresponding stock price in the board information.

Otherwise, the unfair transaction output means 83 may display a stock price chart for a predetermined period of time, and display a stock price fluctuation for a period of time that includes the target transaction data in the stock price chart in a manner that is distinguishable from stock price fluctuations for other periods of time. Such a screen allows for easy-to-understand visualization of stock price fluctuations when a transaction in the unfair transaction candidates is conducted.

Although some or all of the above exemplary embodiments may also be described as in the following Supplementary notes, the present invention is not limited to the following.

(Supplementary note 1) An unfair transaction visualization device comprising: a candidate list output means which outputs a list of unfair transaction candidates indicating one or more transactions suspected of being of a specified type of unfairness; a candidate input means which accepts a selection of an unfair transaction candidate from the output list of the unfair transaction candidates; and an unfair transaction output means which displays target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

(Supplementary note 2) The unfair transaction visualization device according to Supplementary note 1, wherein the transaction data includes information indicating a sell order, a buy order, an execution of a sell order, an execution of a buy order, a cancellation of an order, or a correction of an order.

(Supplementary note 3) The unfair transaction visualization device according to Supplementary note 1 or 2, wherein the transaction data includes a best buy quotation or best sell quotation.

(Supplementary note 4) The unfair transaction visualization device according to any one of Supplementary notes 1 to 3, wherein the unfair transaction output means displays the transaction data indicating transactions conducted between a time of transaction that triggered a suspected unfairness of the selected unfair transaction candidate and a time of transaction at which the unfairness end is estimated, in a manner that is distinguishable from other transaction data for the same issue.

(Supplementary note 5) The unfair transaction visualization device according to any one of Supplementary notes 1 to 4, wherein the unfair transaction output means displays the target transaction data in a manner that is distinguishable from other transaction data for the same issue and on a same day.

(Supplementary note 6) The unfair transaction visualization device according to any one of Supplementary notes 1 to 5, wherein the unfair transaction output means displays a transaction history according to an issue of the unfair transaction candidate, and displays the target transaction data in the transaction history in a manner that is distinguishable from the transaction data of other periods.

(Supplementary note 7) The unfair transaction visualization device according to Supplementary note 6, wherein the unfair transaction output means displays board information at the time the specified transaction is made in the transaction history, and displays the number of ordered stocks for the transaction with the corresponding stock price in the board information.

(Supplementary note 8) The unfair transaction visualization device according to any one of Supplementary notes 1 to 7, wherein the unfair transaction output means displays a stock price chart for a predetermined period of time, and displays a stock price fluctuation for a period of time that includes the target transaction data in the stock price chart in a manner that is distinguishable from stock price fluctuations for other periods of time.

(Supplementary note 9) The unfair transaction visualization device according to Supplementary note 8, wherein the unfair transaction output means enlarges the stock price chart for the period including the target transaction data.

(Supplementary note 10) The unfair transaction visualization device according to any one of Supplementary notes 1 to 9, wherein the unfair transaction candidate is associated with a type of unfair transaction, a customer who conducted a transaction, the issue in which the transaction is conducted, and the time the transaction is conducted.

(Supplementary note 11) The unfair transaction visualization device according to any one of Supplementary notes 1 to 10, wherein the unfair transaction output means displays a display item corresponding to a factor in a manner that is distinguishable from other display items according to information indicating the factor determined to be an unfair transaction candidate.

(Supplementary note 12) An unfair transaction visualization method comprising: outputting a list of unfair transaction candidates indicating one or more transactions suspected of being of a specified type of unfairness; accepting a selection of an unfair transaction candidate from the output list of the unfair trade candidates; and displaying target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

(Supplementary note 13) An unfair transaction visualization program causing a computer to execute: a candidate list output process of outputting a list of unfair transaction candidates indicating one or more transactions suspected of being of a specified type of unfairness; a candidate input process of accepting a selection of an unfair transaction candidate from the output list of the unfair trade candidates; and an unfair transaction output process of displaying target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

This application claims priority based on Japanese patent application 2020-50540 filed on Mar. 23, 2020, the disclosure of which is incorporated herein in its entirety.

### REFERENCE SIGNS LIST

10 Storage unit
20 Transaction data input unit
30 Unfair transaction estimation unit
40 Unfair type input unit
50 Candidate list output unit
60 Candidate input unit
70 Unfair transaction output unit
100 Unfair transaction visualization device

What is claimed is:

1. An unfair transaction visualization device comprising:
a memory storing instructions; and
one or more processors configured to execute the instructions to:
output a list of unfair transaction candidates indicating one or more transactions suspected of being of a specified type of unfairness;
accept a selection of an unfair transaction candidate from the output list of the unfair transaction candidates; and
display target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

2. The unfair transaction visualization device according to claim 1, wherein
the transaction data includes information indicating a sell order, a buy order, an execution of a sell order, an execution of a buy order, a cancellation of an order, or a correction of an order.

3. The unfair transaction visualization device according to claim 1, wherein
the transaction data includes a best buy quotation or best sell quotation.

4. The unfair transaction visualization device according to claim 1, wherein the processor is configured to execute the instructions to
display the transaction data indicating transactions conducted between a time of transaction that triggered a suspected unfairness of the selected unfair transaction candidate and a time of transaction at which the unfairness end is estimated, in a manner that is distinguishable from other transaction data for the same issue.

5. The unfair transaction visualization device according to claim 1, wherein the processor is configured to execute the instructions to
display the target transaction data in a manner that is distinguishable from other transaction data for the same issue and on a same day.

6. The unfair transaction visualization device according to claim 1, wherein the processor is configured to execute the instructions to
display a transaction history according to an issue of the unfair transaction candidate, and display the target transaction data in the transaction history in a manner that is distinguishable from the transaction data of other periods.

7. The unfair transaction visualization device according to claim 6, wherein the processor is configured to execute the instructions to
display board information at the time the specified transaction is made in the transaction history, and display the number of ordered stocks for the transaction with the corresponding stock price in the board information.

8. The unfair transaction visualization device according to claim 1, wherein the processor is configured to execute the instructions to
display a stock price chart for a predetermined period of time, and display a stock price fluctuation for a period of time that includes the target transaction data in the stock price chart in a manner that is distinguishable from stock price fluctuations for other periods of time.

9. The unfair transaction visualization device according to claim 8, wherein the processor is configured to execute the instructions to
enlarge the stock price chart for the period including the target transaction data.

10. The unfair transaction visualization device according to claim 1, wherein
the unfair transaction candidate is associated with a type of unfair transaction, a customer who conducted a transaction, the issue in which the transaction is conducted, and the time the transaction is conducted.

11. The unfair transaction visualization device according to claim 1, wherein the processor is configured to execute the instructions to
display a display item corresponding to a factor in a manner that is distinguishable from other display items according to information indicating the factor determined to be an unfair transaction candidate.

12. An unfair transaction visualization method comprising:
outputting a list of unfair transaction candidates indicating one or more transactions suspected of being of a specified type of unfairness;
accepting a selection of an unfair transaction candidate from the output list of the unfair trade candidates; and
displaying target transaction data, which includes transaction data indicating transactions conducted between a transaction that triggered a suspected unfairness of the selected unfair transaction candidate and a transaction that ended the unfairness, in a manner that is distinguishable from other transaction data for the same issue.

13. A non-transitory computer readable information recording medium storing an unfair transaction visualization program, when executed by a processor, that performs a method for:
outputting a list of unfair transaction candidates indicating one or more transactions suspected of being of a specified type of unfairness;
accepting a selection of an unfair transaction candidate from the output list of the unfair trade candidates; and
displaying target transaction data, which includes transaction data indicating transactions conducted between a transaction that triggered a suspected unfairness of the selected unfair transaction candidate and a transaction that ended the unfairness, in a manner that is distinguishable from other transaction data for the same issue.
